(19) United States
(12) Patent Application Publication
(10) Pub. No.: US 2016/0177564 A1
(43) Pub. Date: Jun. 23, 2016

(54) SLIDING WALL SYSTEM

(71) Applicant: DORMA Deutschland GmbH, Ennepetal (DE)

(72) Inventor: Kenan AYKAS, Ennepetal (DE)

(21) Appl. No.: 14/945,017

(22) Filed: Nov. 18, 2015

(30) Foreign Application Priority Data
Dec. 18, 2014 (EP) 14199001.0

(51) Int. Cl. E04B 2/82; E05F 11/00; E05D 15/06; E04B 2/74; E06B 11/02

(52) U.S. Cl. CPC E04B 2/827; E04B 2/7405; E06B 11/02; E05D 15/0626; E05F 11/00; E04B 2/7403

(57) ABSTRACT

A horizontal sliding wall system includes a ceiling guide with at least one running rail, and at least one door leaf element connected to a roller carriage, which is disposed in the ceiling guide to be displaceable. At least one door leaf element is configured in the ceiling guide to be pivotable and displaceable as a swing sliding leaf. The swing sliding leaf includes a swing leaf door and an interlocking handle, which is configured to be rotatable between first and second interlocking positions, and further includes first and second gear arrangements. The first gear arrangement transforms the rotary motion of the interlocking handle into a vertical translatory motion of first and second interlocking rods. The second gear arrangement is coupled to at least one of the interlocking rods such that the vertical translatory motion of one interlocking rod is transformed into a horizontal movement of a third interlocking rod.

### TECHNICAL FIELD

The disclosure relates to a horizontal sliding door system, comprising a ceiling guide with at least one running rail, as well as to at least one door leaf element, which is connected to a roller carriage, which is supported to be displaceable in the ceiling guide.

### BACKGROUND

Sliding wall systems and the door leaf elements thereof are known in multi-leaf entry doors, in wall sliding elements used as room dividers or in wall elements in frontal areas of buildings, in particular in restaurants and business premises, with the intention, depending on the weather conditions, to have sales room freely accessible, respectively to keep it closed. Generally, the door leaf elements are accommodated to be displaceable in ceiling guides, which are mounted to the ceiling. In this case, the individual leaf elements may be parked in a lateral position, so they do not represent any barriers for entering business traffic.

With increasing requirements in terms of energy efficiency in and at buildings, the requirements in terms of thermal insulation of such sliding wall systems increase.

The disclosure provides an improved thermal separation of a sliding wall system, which is simple and inexpensively manufactured and allows for an ease of manipulation of a swing sliding leaf within a sliding wall system.

### SUMMARY

The inventive horizontal sliding wall system comprises a ceiling guide with at least one running rail, as well as at least on door leaf element, which is connected to a roller carriage, which is disposed to be displaceable at the ceiling guide, wherein at least one door leaf element is configured to be pivotable and displaceable as a swing sliding leaf in the ceiling guide, wherein the swing sliding leaf comprises a swing leaf door, as well as an interlocking handle, which is embodied to be rotatable between a first interlocking position and a second interlocking position, and comprises a first gear arrangement and a second gear arrangement, wherein the first gear arrangement transforms the rotary motion of the interlocking handle into a vertical translatory motion of a first interlocking rod and of a second interlocking rod, wherein the second gear arrangement is coupled to at least one of the interlocking rods, so that the vertical translatory motion of one of the interlocking rods is transformed into horizontal movement of a third interlocking rod, the second interlocking rod, at its ceiling-side distal end, includes an interlocking bolt, which in the first interlocking position of the interlocking handle engages in a stationary pivot bearing, and the first interlocking rod, at its bottom-side end, includes an interlocking bolt, which in the first interlocking position of the interlocking handle engages in a bottom-side stationary pivot bearing, so that a rotary motion of the swing sliding leaf about the interlocking rods can be caused, and a displacement of the door leaf element is prevented, wherein, in the second interlocking position of the interlocking handle, a rotary motion of the swing sliding leaf about the interlocking rods is prevented and a displacement of the door leaf element enabled, wherein the third interlocking rod includes a coupling means, which, in the second interlocking position of the interlocking handle, is in engagement with a corresponding coupling means of the swing leaf door, such that a rotary motion of the swing sliding leaf about the interlocking rods is prevented, however, a displacement of the door leaf element enabled. This arrangement allows for realizing a particularly simple and ergonomically advantageous interlocking function respectively control function of a swing sliding door within a sliding wall system.

It is particularly preferred, if the second gear arrangement comprises at least one first lever and a second lever, wherein the first lever is articulately supported at the second interlocking rod and articulately supported at the second lever, wherein the second lever is supported to be displaceable in the horizontal door leaf frame of the door leaf. This arrangement offers the user a particularly simple and effortless and therefore energy-saving use of the interlocking system.

In this context, it may be furthermore advantageous, if the second lever is coupled to the interlocking rod. This is favorable from the technical manufacturing point of view as well as with regard to the selection of materials, because the second lever and the interlocking rod may be manufactured from different materials.

Thus, it is for example also conceivable that the third interlocking rod is guided to be displaceable in the horizontal door leaf frame. It is thereby in particular possible to dispose the third interlocking rod within the horizontal profile frame.

With the intention to further reduce the required expenditure of forces for manipulating the interlocking system, it may be advantageous, if the interlocking rod is coupled to at least one, preferably to two sliding elements, which are accommodated to be displaceable in the horizontal door leaf frame of the door leaf.

With the intention not to interfere with the thermal separation by means of the interlocking system, it is furthermore advantageous, if a sliding element presents a thermal conductivity of 0.1 to 2 W m⁻¹ K⁻¹, preferred of 0.1 to 1.5 W m⁻¹ K⁻¹, in particular preferred of 0.1 to 1 W m⁻¹ K⁻¹ at 20° C., determined according to DIN 52612, and includes a thermal linear expansion coefficient of 0.1 to 2, preferred of 0.5 to 1.5, in particular preferred of 0.5 to 1.0*10⁻⁶ K⁻¹ at 20° C., measured according to ISO 11359.

A constructive simple yet reliable embodiment of the disclosure results preferably from the third interlocking rod including a coupling means, which comprises a groove-shaped reception, with which a corresponding coupling means of the swing leaf door can be brought into positive engagement.

Furthermore, it is advantageous, if the first interlocking rod and the second interlocking rod are disposed in true alignment on a common vertical axis, whereby a uniform pivoting axis can be realized for the swing leaf door.

It has proven to be ergonomically particularly favorable and advantageous, if the interlocking handle is disposed on a vertical frame on the pull-side.

With the intention to further improve the interlocking mechanism for the horizontal sliding wall system, it may be in particular intended that the first interlocking rod is vertically guided in at least one guide and/or that the second interlocking rod is vertically guided in at least one guide.

With the intention to ensure a simple installation and adjustability of the guide, it is preferred that the guide be disposed within a vertical frame to be releasable. In this context, it is also particularly preferred that the guide be disposed within the vertical frame to be displaceable. Furthermore, it is particularly advantageous, if the guide is non-positively and/or positively fixable within the vertical frame.

With the intention to further improve the thermal separation effect of the horizontal sliding wall system, it is also particularly preferred, if a guide presents a thermal conductivity of 0.1 to 2 W m⁻¹ K⁻¹, preferred of 0.1 to 1.5 W m⁻¹ K⁻¹, in particular preferred of 0.1 to 1 W m⁻¹ K⁻¹ at 20° C., determined according to DIN 52612, and presents a thermal linear expansion coefficient of 0.1 to 2, preferred 0.5 to 1.5, in particular preferred of 0.5 to 1.0*10⁻⁶ K⁻¹ at 20° C., measured according to ISO 11359.

In another embodiment of the inventive sliding wall system, a stationary pivot bearing is configured in the ceiling guide and/or in the building ceiling.

### BRIEF DESCRIPTION OF THE DRAWINGS

In the Figures:

FIG. 1 shows a diagrammatically simplified frontal view of a sliding wall system according to the present disclosure,

FIG. 2 shows a cross-sectional view through the ceiling guide of the sliding wall system,

FIG. 3 shows a cross-sectional view of a vertical door frame of a door leaf element of the sliding wall system,

FIG. 4 shows a cross-sectional view of a horizontal door frame of a door leaf element of the sliding wall system,

FIG. 5 shows a cross-sectional view through the drainage rail of the sliding wall system,

FIG. 6 shows a detailed view of a groove-shaped reception for an insulating web configured in a door leaf element,

FIG. 7 shows a functional outline of an interlocking for a sliding pivoting door in the sliding condition, and

FIG. 8 shows a functional outline of an interlocking for a sliding pivoting door in the pivoting condition.

### DETAILED DESCRIPTION OF THE DRAWINGS

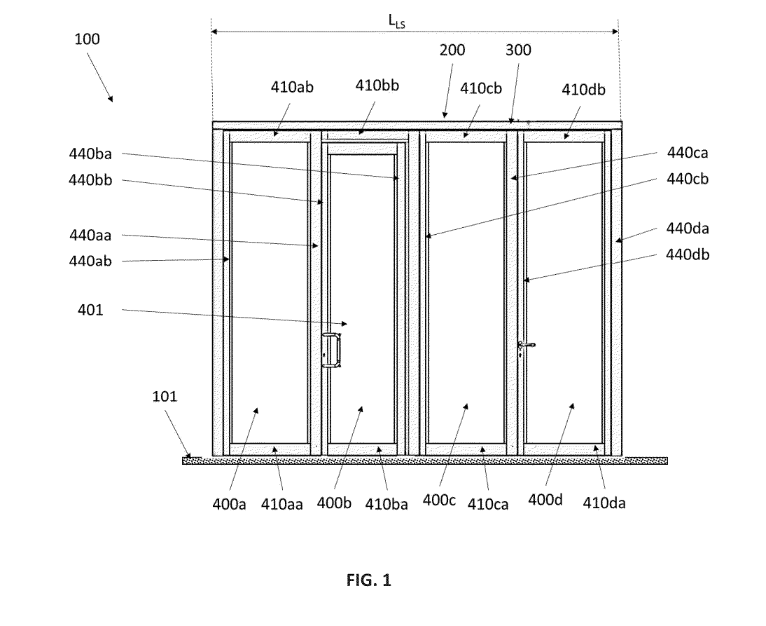

FIG. 1 shows a perspective view of a sliding wall system 100 according to the present disclosure. The inventive sliding wall system 100 comprises a ceiling guide 200 and four door leaf elements 400a, 400b, 400c, 400d, which are disposed next to each other in the longitudinal direction L of the sliding wall system 100 in the ceiling guide 200. The ceiling guide 200, which is configured as an integral running rail 300, has a length which corresponds to four times the width of the door leaf elements 400a, 400b, 400c, 400d. As an alternative, the ceiling guide 200 may be composed of several ceiling guide elements.

The ceiling guide 200 may be attached directly to the ceiling of the building 201. Displacing the door leaf elements 400 may be performed manually and/or by motor.

In particular, the inventive sliding wall system 100 of FIG. 1 includes a first door leaf element 400a, a second door leaf element 400b, a third door leaf element 400c, and a fourth door leaf element 400d, which may be equipped with particular functions. The second door leaf element 400b, as well as the fourth door leaf element 400d are disposed to be pivotable, wherein the first door leaf element 400a and the third door leaf element 400c can just be displaced in the ceiling guide 200. Furthermore, the second door leaf element 400b is disposed in the ceiling guide 200 to be pivotable and displaceable. Thus, the first door leaf element 400a and the third door leaf element 400c serve as sliding leaves, the fourth door leaf element 400d as a swing leaf or as a double-action leaf and the second door leaf element 400b as a swing sliding leaf.

The gap between the door leaf elements 400a, 400b, 400c, 400d and the ceiling guide 200 or the building floor 101 may vary due to mounting tolerances and/or due to frequent use over the time, respectively relative movement with regard to each other as well as thermal expansion or thermal contraction. Said gap is sealed visually and thermally by means of horizontally extending brushes 490a, 490b, wherein the brushes 490a, 490b are disposed at the ceiling-side horizontal door leaf frames 410ab, 410bb, 410cb, 410db and/or the floor-side horizontal door leaf frames 410aa, 410ba, 410ca, 410da of the door leaf elements 400a, 400b, 400c, 400d.

The brushes 490a, 490b may include a plastic material film, which may be disposed in the brushes 490a, 490b approximately in the center.

Preferably, the plastic material film is manufactured from polyethylene. In particular, polyethylene has a high ductility and elongation at break, a good gliding behavior, reduced wear, a good temperature resistance and very low water absorption. The plastic material film may be in particular also configured to include two layers.

Preferably, the plastic material film has a film strength between 30 μm and 200 μm, in particular preferred between 50 μm and 150 μm. The flexibility of the brushes 490a, 490b can be controlled via the material strength. The specified film strengths show an optimal sealing effect.

In this context, it is advantageous, if the plastic material film in the condition disposed in the brush 490a, 490b is set back by 2% to 20%, preferred by 5% to 10%, with regard to the brush height to the inside, towards the basic area of the brush 490a, 490b. This arrangement achieved a good sealing effect, while simultaneously realizing a minimized friction effect of the brushes 490a, 490b as well as a minimized noise development.

With the intention to ensure sufficient tightness, without damaging the floor and/or the ceiling guide 200, preferably each one of the brushes 490a, 490b contacts the floor and/or the ceiling guide 200 with a contact pressure of 0.01 N/mm2 to 0.5 N/mm2.

Furthermore, it is preferred, if the brushes 490a, 490b in the door leaf elements 400a, 400b, 400c, 400d are essentially identical.

FIG. 1 reveals furthermore that the horizontal sliding wall system 100 comprises a door leaf element 400a, 400b, 400c, 400d with at least two vertical door frames 440a, 440b and at least two horizontal door frames 410a, 410b, wherein a vertical door frame 440a, 440b comprises a first vertical frame profile 450a and at least one second vertical frame profile 450b, and wherein a horizontal door frame 410a, 410b comprises a first horizontal frame profile 420a and at least one second horizontal frame profile 420b, and wherein all abutting edges of the ceiling guide 200, of the horizontal frame profiles 420a, 420b, and of the vertical frame profiles 450, 450b in the assembled condition of the sliding wall system 100 exclusively form horizontal or vertical joints, which creates a particularly harmonious and aesthetical appearance of the sliding wall system 100.

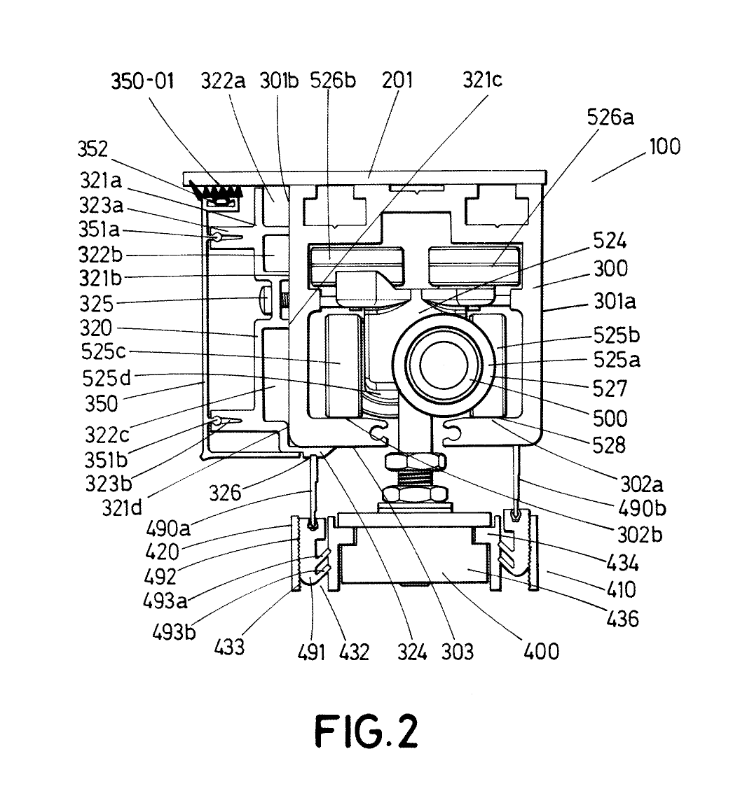

FIG. 2 shows a cross-section through the ceiling guide 200 of the sliding wall system 100 of FIG. 1. The ceiling guide 200 is affixed to the building ceiling 201. The ceiling guide 200 comprises a running rail 300, in which a roller carriage 500 is disposed to be displaceable. A door leaf element 400 is disposed in a suspended manner at the roller carriage 500.

Essentially, the running rail 300 is configured in a U-shape, wherein the free branches of the U-shaped running rail 300 form the frontal faces 301a, 301b of the running rail 300. Furthermore, running surfaces 302a, 302b for guiding the roller carriage 500 are conformed to the distal end of the free branches of the U-shaped running rail 300.

The running rail 300 is formed from a first material having a thermal conductivity of 75 to 235 W m⁻¹ K⁻¹, and a linear thermal expansion coefficient of 21 to 24*10⁻⁶ K⁻¹.

Preferably, the two frontal faces 301a, 301b of the running rail 300 have a surface roughness parallel to the extrusion direction of Ra 0.1 to 3, preferred of Ra 0.2 to 2, in particular preferred of Ra 0.75 to 1.8, measured according to DIN EN ISO 4287. Herewith, particularly advantageous adhesion and contacting properties can be achieved for the thermal separation profile to be attached to the running rail and to be explained in detail later.

The thermal separation profile 320 is disposed at a frontal face 301b of the running rail 300 via an attachment means 325, in particular a screwed, clamped or bonded connection. Even though in FIG. 2 just one thermal separation profile 320 is disposed at one of the frontal faces 301b, obviously it is possible and advantageous to provide a thermal separation profile at both frontal faces 301a, 301b.

The thermal separation profile 320 abuts against the frontal face 301b of the running rail 300. For the abutment, the thermal separation profile 320 comprises a plurality of locating surfaces separated from each other 321a, 321b, 321c, 321d between the thermal separation profile 320 and the frontal face 301b of the running rail 300. With the intention to further improve the thermal separation, it is preferred that all the locating surfaces 321a, 321b, 321c, 321d of the thermal separation profile 320 correspond to between 1 to 10% of the surface of a frontal face 301b of the running rail 300.

On the side 301b facing the running rail 300, the thermal separation profile 320 includes at least one open channel-like depression 322a, 322b, 322c, whereby the structural stability of the thermal separation profile 320 as well as the thermal separation properties thereof can be further improved. In the exemplary embodiment shown, a first channel-like depression 322a, a second channel-like depression 322b, as well as a third channel-like depression 322c are configured.

For affixing a running rail screen 350, the thermal separation profile 320 includes at least one connecting means 323a, 323b, preferred at least two connecting means 323a, 323b for the reception of a running rail screen 350 with corresponding connecting means 351a, 351b for the detachable connection to the thermal separation profile 320 with the running rail screen 350.

Furthermore, the thermal separation profile 320 has a locating branch 324, which abuts against the exterior horizontal running rail portion 303 of the running rail 300.

The locating branch 324, by means of the abutment against a horizontal surface of the running rail 300, ensures a defined positioning of the thermal separation profile 320 at the running rail 300.

A groove-like guide 326 for the reception of the free bristle ends of a brush 490a may be provided at the locating branch 324. The guide 326 is configured in that the free bristle ends of the brush 490a, which is disposed below the running rail 300 in the horizontal door leaf frame 410, are at least in sections enclosed by the groove-like guide 326. On the one hand, a visual appealing joint image of the sliding wall system 100 is realized, because fraying of the bristle ends of the brush 490a, which usually happens in operating sliding wall systems, is visually concealed by the groove-like guide 326. Furthermore, the groove-like guide 326 effects an improved wind tightness of the sliding wall system, because by affixing the free end of the bristles of the brush 490a, the latter has an improved mechanical stability.

The thermal separation profile 320 is made from a second material having a thermal conductivity of 0.02 to 0.1 W m⁻¹ K⁻¹, and a linear thermal expansion coefficient of 40 to 300*10⁻⁶ K⁻¹.

The thermal separation profile 320 is in particular formed from one piece. Preferably, the thermal separation profile 320 extends over 50 to 100%, preferred 75 to 100%, in particular preferred 90 to 100% of the length L_{LS} of the running rail 300. Furthermore, it is preferred that the thermal separation profile 320 extends over 50 to 100%, preferred 75 to 100%, in particular preferred 90 to 100% of the height EU of the running rail.

The running rail screen 350 is affixed to be detachable at the thermal separation profile 320 via the connecting means 351a, 351b, which, with the corresponding connecting means 323a, 323b of the thermal separation profile 320, produce a non-positive and/or positive connection.

Essentially, the running rail screen 350 is configured to be L-shaped and, at its ceiling-side distal end, it has a groove 352 for the reception of a sealing means 350-01 for sealing the running rail screen 350 with regard to the ceiling structure 201 of a building.

The running rail screen 350 is formed from a third material having a thermal conductivity of 75 to 235 W m⁻¹ K⁻¹, and a linear thermal expansion coefficient of 21 to 24*10⁻⁶ K⁻¹.

FIG. 2 reveals furthermore that the door leaf element 400 comprises a horizontal frame profile 420, in which a brush 490 is accommodated for sealing the horizontal gap between the door leaf element 400 and the running rail 300, wherein means for the vertical adjustment of the brush 490a in the frame profile 420 are provided within the horizontal frame profile 420. Said means for the vertical adjustment of the brush 490 in the horizontal frame profile 420, according to the exemplary embodiment shown in FIG. 2, comprise a brush profile 491, in which the brush 490 is accommodated, and an essentially U-shaped reception 432 in the horizontal frame profile 420, in which the brush profile 491 is accommodated to be vertically adjustable and/or latchable. The brush profile 491 includes a first latching means 492, which cooperates with the corresponding second latching means 433 of the U-shaped reception 432 in such a way that an adjustable latching of the brush profile 491 is effected in the reception 432. For this purpose, at least one spring element 493a, 493b is disposed at the brush profile 491, which element, for generating a spring force, props-up in the reception 432 such that the brush profile 491 is affixed in the reception 432. A spring element 493a, 493b may be formed in particular in one piece with the brush profile 491.

FIG. 2 shows a roller carriage 500 within the ceiling guide 200 of the sliding wall system 100 according to the present disclosure. The roller carriage 500 is connected to the door leaf element 400 by means of a connecting element in the form of a pad 436, which is introduced into the ceiling-side horizontal door leaf frame 410 and props-up against the shoulder 434. The door leaf element 400 is thereby disposed to be displaceable in the ceiling guide 200, which is configured from running rails 300 and if required turnouts (not shown). A plurality of roller carriages 500 is provided in the sliding wall system 100.

Preferably, all door leaf elements 400a, 400b, 400c, 400d include identical roller carriages 500. Preferably, a door leaf element 400a, 400b, 400c, 400d is guided in the running rail 300 by means of at least two, preferred exactly two roller carriages 500.

The roller carriage 500 of FIG. 2 has a basic body 524, at which a plurality of running rollers 525a, 525b, 525c, 525d and a plurality of guiding rollers 526a, 526b are disposed. As revealed in FIG. 2, the roller carriage 500 comprises four running rollers 525a, 525b, 525c, 525d and four guiding rollers 526a, 526b, 526c, 526d (wherein the guiding rollers 526c, 526d are concealed by the guiding rollers 526a, 526b), wherein the running rollers 525a, 525b, 525c, 525d are disposed vertically to the guiding rollers 526a, 526b, 526c, 526d. Thus a failsafe displacement and guidance of the door leaf element 400 can be ensured in the ceiling guide 200.

The running rollers 525a, 525b, 525c, 525d, which are configured to be identical, present respectively one roller body 527 with a running surface 528, wherein the roller bodies 527 roll on two running surfaces 302a, 302b of the running rail 300.

The basic body 524 has a modulus of elasticity at 20° C. of 70 kN/mm² to 100 kN/mm², preferred approximately 85 kN/mm², according to EN ISO 6892-1:2009, a shear modulus at 20° C. of 20 kN/mm² to 60 kN/mm², preferred approximately 40 kN/mm², according to DIN 53445, and a density at 20° C. of 2 g/cm³ to 7 g/cm³, preferred approximately 6.7 g/cm³, according to ISO 527-1/-2.

The roller body 527 has a modulus of elasticity at 20° C. of 2 kN/mm² to 4 kN/mm², preferred approximately 3 kN/mm², according to ISO 527-1/-2, a shear modulus at 20° C. of 0.5 kN/mm² to 1 kN/mm², preferred approximately 0.8 kN/mm², according to DIN ISO 1827:2010-07, and a density at 20° C. of 1 g/cm³ to 2 g/cm³, preferred approximately 1.4 g/cm³, according to DIN EN ISO 1183. Furthermore, the roller surface 528 of the roller body 527 has a surface roughness Ra of 0.01 μm to 3 μm, preferred of 0.05 μm to 2 μm, according to DIN EN ISO 4287.

Furthermore preferably, the roller body 527 has a diameter of 16 mm to 20 mm, particularly preferred of 18.5 mm. Preferably, the roller surface 528 of the roller body 527 has a roller surface width of 5 mm to 9 mm, preferred of 7 mm.

Furthermore, the roller body 527 has a water absorption of 0.3% at standard atmosphere according to ISO 62. The water absorption at standard atmosphere indicates the weight increase in percentage of a body by absorbing water when stored at a temperature of 23° C. and a humidity of 50%. According to the disclosure, the water absorption of the roller body at standard atmosphere is kept low. High water absorption results in a high flattening out of the roller body 527, whereby noise is caused when the roller body 527 of the running roller 525 rolls on the running surface 529 of the ceiling guide 200.

Furthermore, the roller body 527 has water absorption of 1.4% at storage in water according to ISO 62. The water absorption at storage in water indicates the weight increase in percentage of a body by water absorption, when stored in water. The roller body 527 of a running roller 525 is configured such that its water absorption is kept very low, when stored in water. Thus, flattening out of the roller body 527, e.g. in a sliding wall system 100, which is disposed in an external room, is reduced. Thereby, low-noise operation under different weather conditions can be ensured.

Furthermore, the roller body 527 has a flattening of less than 0.7% with regard to the diameter of the roller body 527 after 8 hours of downtime of the roller body 527. The low admissible flattening of the roller bodies 527 considerably increases the running smoothness of the inventive sliding wall system 100. The flattening of a roller body 527 is measured in that a test load of 200 N is applied in vertical direction to the roller body 527, which is disposed on a surface. Particularly preferred, the roller body 527 with a diameter of 18.5 mm has a maximum flattening of 0.12 mm after 8 hours of downtime.

The running surfaces 529 of the ceiling guide 200 have a modulus of elasticity at 20° C. of 60 kN/mm² to 80 kN/mm², preferred approximately 70 kN/mm², according to EN ISO 6892-2:2009, a shear modulus at 20° C. of 10 kN/mm² to 40 kN/mm², preferred approximately 27 kN/mm², according to DIN 53445, and a density at 20° C. of 2 g/cm³ to 5 g/cm³, preferred approximately 3 g/cm³, according to ISO 527-1/-2. Furthermore, the running surfaces 529 have a surface roughness Ra of 0.05 to 1.0 μm, preferred approximately 0.5 μm, measured according to DIN EN ISO 4287.

The running surface 302 have respective internal surface creasings, essentially parallel to the displacement direction V of the door leaf element 400. An internal surface creasing is understood to be an essentially linear surface structure comprising a plurality of parallel linearly-shaped depressions in the running surface 302, which are produced by the extrusion process. Furthermore, the running surfaces 302 of the ceiling guide 200 are configured in one piece with the ceiling guide 200. Thus, a very compact structure is possible. Furthermore, potential mounting errors, such as oblique positions are eliminated, whereby noise could be caused, when the door leaf elements 400 roll in the ceiling guide 200. The ceiling guide 200 has a density of 2 to 5 g/cm³, preferred approximately 3 g/cm³, according to ISO 527-1/-2. The running surfaces 302 of the ceiling guide 200 include each one running surface width, which is larger than the roller surface width of the roller surfaces 528 of the roller bodies 527.

Each of the roller bodies 527 is supported at the roller carriage 500 in particular by means of an enclosed ball bearing. The roller body 527 includes an axis with two knurlings, by means of which the roller body 527 is torque-proof attached to the basic body 524 of the roller carriage 500.

The axis also serves as an inner ring of the ball bearing. The ball bearing has seven balls, which are greased with lithium soap grease.

Furthermore, the static surface pressure between a running roller 525 and the running surface 529 of the ceiling guide 200 amounts to at least 2.5 kg/mm², preferred between 2.5 and 100 kg/mm². This results in eliminating any squeaking noise when displacing the door leaf elements 400.

The average displacement speed of the roller carriage 500 ranges between 0.05 and 0.5 m/s, preferred approximately 0.2 m/s.

Furthermore, the start-up torque of a door leaf element 400, which is disposed to be displaceable in the ceiling guide 200, such as the door leaf element 400a, 400b and/or 400c, 400d of FIG. 1, amounts to 8 N to 15 N, preferred 10 N to 14 N, and particularly preferred 11 N to 13 N for a weight of the door leaf element 400a, 400b and/or 400c, 400d of 175 kg. After 100.000 cycles, the start-up torque of the door leaf element 400a, 400b and/or 400c, 400d still amounts to 15 N to 21 N, preferred 16 N to 20 N, in particular preferred 17 N to 19 N.

The inventive roller carriage 500 as well as the inventive running surfaces 529 of the ceiling guide 200 allow for a noise-reduced movement of the sliding wall system 100. The abrasion of the roller bodies 527 is reduced and thereby the service life of the roller carriage 500 is considerably increased. In addition, squeaking of the running rollers 525 may be eliminated.

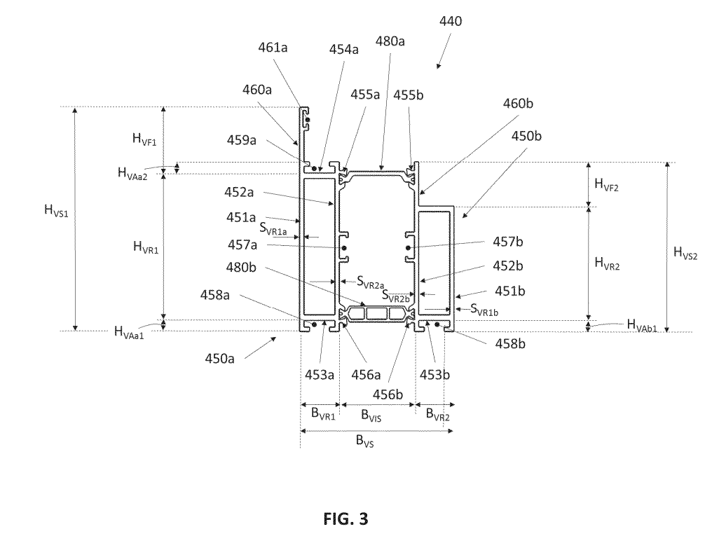

FIG. 3 shows a vertical door frame 440 of a door leaf element 400 of the inventive sliding wall system 100.

The door leaf element 400 comprises at least two vertical door frames 440a, 440b. Preferably, the vertical door frames 440a, 440b are configured to be essentially geometrical, in particular also essentially identical in material.

A vertical door frame 440a, 440b comprises a first vertical frame profile 450a and at least one second vertical frame profile 450b, which both are configured to be essentially rectangular, and include respectively two narrow sides 453a, 454a, 453b, 454b opposite each other, and two long sides 451a, 452a, 451b, 452b opposite each other.

The two vertical frame profiles 450a, 450b are interconnected and spaced apart from each other by means of two insulating webs 480a, 480b.

The first vertical frame profile 450a and/or the second vertical frame profile 450b is/are in particular made from a material, which has a thermal conductivity of 75 to 235 W m⁻¹ K⁻¹ at 20° C., determined according to DIN EN ISO 10456, and a linear thermal expansion coefficient of 21 to 24*10⁻⁶ K⁻¹ at 20° C., determined according to DIN 51045.

Preferably, the ratio of thermal conductivity of the first vertical frame profile 450a to the thermal conductivity of the second vertical frame profile 450b ranges between 0.9:1 to 1.1:1, preferred 0.95:1 to 1.05:1, in particular preferred approximately 1:1.

Furthermore it should be preferred, if the ratio of the linear thermal expansion coefficient of the first vertical frame profile 450a to the linear thermal expansion coefficient of the second vertical frame profile 450b ranges between 0.9:1 to 1.1:1, preferred 0.95:1 to 1.05:1, in particular preferred amounts to approximately 1:1.

It is likewise advantageous, if the ratio of the linear thermal conductivity of the first and/or the second vertical frame profile 450a, 450b to the thermal conductivity of the first and/or second insulating web 480a, 480b ranges between 50:1 to 800:1, preferred between 75:1 to 750:1.

According to another preferred embodiment of the disclosure, the ratio of the wall thickness of the first vertical frame profile 450a to the wall thickness of the second vertical frame profile 450b ranges between 0.9:1 to 1.1:1, preferred 0.95:1 to 1.05:1, in particular preferred amounts to approximately 1:1.

The first vertical frame profile 450a and the second vertical frame profile 450b include a groove-shaped reception 458a, 458b, 459a at least at one narrow side 453a, 454a, 453b, 454b, wherein the groove-shaped receptions 458a, 458b, 459a are configured in cross-section preferably essentially geometrically identical.

The first vertical frame profile 450a and the second vertical frame profile 450b include respectively at least one, preferably at least two, in particular preferred at least three groove-shaped receptions 455a, 456a, 457a, 455b, 456b, 457b at least at one of the long sides 451a, 452a, 451b, 452b directed to the outside, wherein at least one groove-shaped reception 455a, 456a, 455b, 456b, preferably at least two groove-shaped reception 455a, 456a, 455b, 456b are configured for the non-positive and/or positive reception of insulating webs 480a, 480b.

The groove-shaped reception 455a, 456a, 455b, 456b are configured preferably essentially geometrically identical.

Two of the groove-shaped receptions 455a, 456a, 455b, 456b are configured geometrically essentially identical and are respectively disposed at the distal end of the long side 451a, 452a, 451b, 452b oriented to the outside of the vertical frame profile 450a, 45b and are configured for the non-positive and/or positive reception of an insulating web 480a, 480b.

As furthermore revealed in FIG. 3, at least one of the long sides 451a, 452a, 451b, 452b, preferably exactly one of the long sides 451a, 451b of the vertical profile 450a, 450b comprises an extension 460a, 460b in true alignment with the long side 451a, 452a, 451b, 452b, wherein, at the distal end of the extension 460a, at least one groove-shaped reception 461a is configured in particular for the reception of a sealing profile.

The ratio of wall thickness of the first vertical frame profile 450a to the wall thickness of the extension 460a of the first vertical frame profile 450a ranges preferably between 0.9:1 to 1.1:1, preferred 0.95:1 to 1.05:1, in particular preferred amounts to approximately 1:1, and in particular also the ratio of wall thickness of the second vertical frame profile 450b to the wall thickness of the extension 460b of the second vertical frame profile 450b ranges between 0.9:1 to 1.1:1, preferred 0.95:1 to 1.05:1, in particular preferred amounts to approximately 1:1.

Advantageously, the first vertical frame profile 450a has a ratio of frame profile height (H_{VR1}) to frame profile width (B_{VR1}) of 1.1:1 to 5:1, preferred 1:1 to 4.5:1, in particular preferred of 3:1 to 4:1, and most particularly preferred of 3.67:1. Furthermore preferably, the second vertical frame profile 450b has a ratio of frame profile height (H_{VR2}) to frame profile width (B_{VR2}) of 1.1:1 to 5:1, preferred 2:1 to 4:1, in particular preferred of 2:1 to 3:1, and most particularly preferred of 2.89:1.

Furthermore, it is preferred, if the ratio of frame profile height (H_{VR1}) to frame profile width (B_{VR1}) of the first vertical frame profile 450a to the ratio of frame profile height (H_{VR2}) to frame profile width (B_{VR2}) of the second vertical frame profile 450b ranges between 1.1:1 to 2:1, preferred 1.1:1 to 1.5:1, in particular preferred amounts to approximately 1.27.

It may be likewise preferred, if the first vertical frame profile 450a has a ratio of frame profile height (H_{VR1}) to frame profile wall thickness (WS_{VR1}) of 10:1 to 50:1, preferred of 20:1 to 40:1, in particular preferred of 25:1 to 35:1, most particularly preferred approximately 33:1. In an advantageous further development of the disclosure, it is likewise preferred, if the second vertical frame profile 450b has a ratio of frame profile height (H_{VR2}) to frame profile wall thickness (WS_{VR2}) of 10:1 to 50:1, preferred 10:1 to 30:1, in particular preferred of 20:1 to 30:1, most particularly preferred of 26:1.

As furthermore revealed in FIG. 3, one of the insulating webs 480a, 480b comprises a hollow space in cross-section, which is preferably essentially formed rectangularly and furthermore, particularly preferred includes a plurality of essentially rectangularly hollow spaces. The thermal separation effect, as well as the structural rigidity of the insulating web 480b is hereby increased.

The insulating web 480a is configured like a stripe and includes in cross-section respectively one shoulder at its distal ends.

The insulating webs 480a, 480b, in cross-section at their distal ends, include means for realizing a positive and/or non-positive connection to the groove-shaped receptions 455a, 456a, 455b, 456b of the first and second vertical frame profiles 450a, 450b.

In the mounted condition of the insulating webs 480a, 480b, they form an essentially planar surface in the groove-shaped receptions 451a, 451a, 451b, 452b of the vertical frame profiles 450a, 450b.

The ratio of the width (B_{VIS}) of the insulating webs 480a, 480b in a vertical door leaf frame 440 to the width (B_{VR1}) of the first vertical frame profile 450a ranges preferably between 1:1 to 3:1, preferred 1.5:1 to 2.5:1, in particular preferred 1.75:1 to 2.25:1.

The first vertical frame profile 450a has a first vertical sight height (H_{VS1}) and the second vertical frame profile 450b has a second vertical sight height (H_{VS2}), wherein the ratio of the sight heights (H_{VS1}):(H_{VS2}) ranges between 1:1 to 1:2, preferred 1:1 to 1:1.5.

Preferably, the ratio of the vertical sight width (B_{VS}) of a vertical door leaf frame 440 to the vertical sight height (H_{VS1}) of the first vertical frame profile 450a amounts to 1:1 to 1:3, preferred 1:1 to 1:2, in particular preferred 1:1.2 to 1:1.8.

Furthermore, it is likewise preferred, if the ratio of the vertical sight width (B_{VS}) of a vertical door leaf frame 440 to the horizontal sight width (B_{HS}) of a horizontal door leaf frame 410 ranges between 0.9:1 to 1.1:1, preferred 0.95:1 to 1.05:1, in particular preferred amounts to approximately 1:1.

The groove-shaped receptions 455a, 456a, 455b, 456b are configured for the non-positive and/or positive reception of the insulating webs 480a, 480b. The groove-shaped reception 455a, 455b, 456a, 456b are formed in particular geometrically essentially identical.

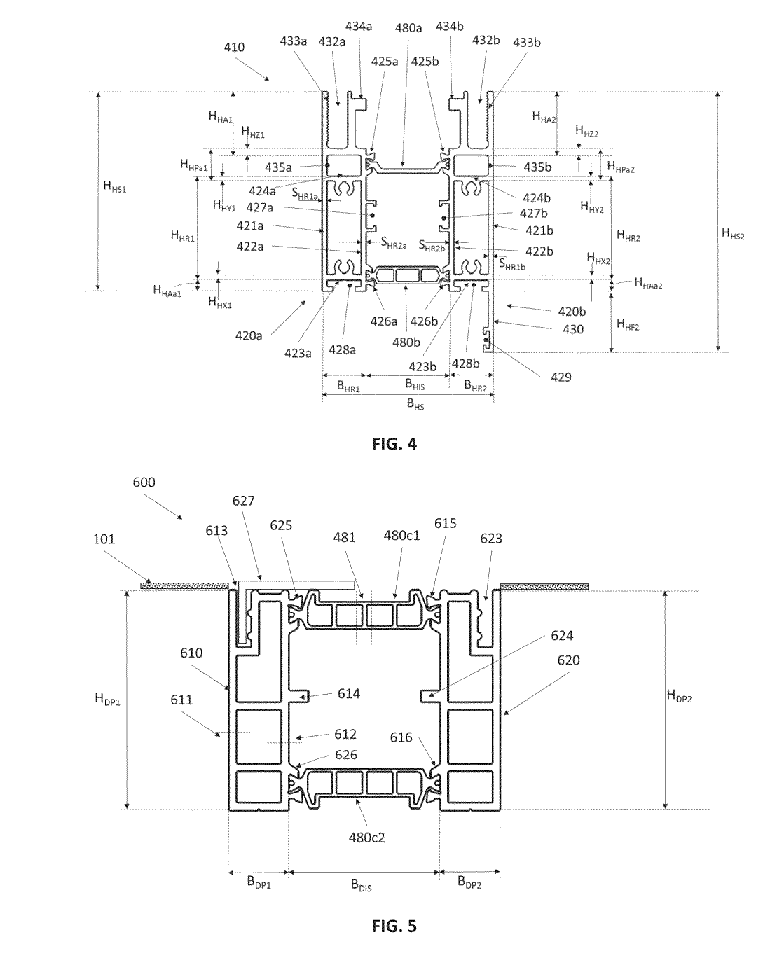

FIG. 4 shows a horizontal door leaf frame 410a, 410b of a sliding wall system 100 in the cross-sectional view

A door leaf element 400a, 400b, 400c, 400d comprises at least two horizontal door frames 410a, 410b, wherein a horizontal door frame 410a, 410b comprises a first horizontal frame profile 420a and at least one second horizontal frame profile 420b. Both horizontal frame profiles 420a, 420b are essentially configured rectangularly in cross-section and respectively two narrow sides 423a, 424a, 423b, 424b opposite each other and two long sides 421a, 422a, 421b, 422b opposite each other are provided.

The two horizontal frame profiles 420a, 420b are interconnected and spaced apart from each other by means of at least two insulating webs 480a, 480b.

The first horizontal frame profile 420a and/or the second horizontal frame profile 420b is/are in particular made from a material, which has a thermal conductivity of 75 to 235 W m⁻¹ K⁻¹ at 20° C., determined according to DIN EN ISO 10456, and a linear thermal expansion coefficient of 21 to 24*10⁻⁶ K⁻¹ at 20° C., determined according to DIN 51045.

Preferably, the ratio of thermal conductivity of the first horizontal frame profile 420a to the thermal conductivity of the second horizontal frame profile 420b ranges between 0.9:1 to 1.1:1, preferred 0.95:1 to 1.05:1, in particular preferred amounts to approximately 1:1.

The ratio of the linear thermal expansion coefficient of the first horizontal frame profile 420a to the linear thermal expansion coefficient of the second horizontal frame profile 420b ranges preferably between 0.9:1 to 1.1:1, preferred 0.95:1 to 1.05:1, in particular preferred amounts to approximately 1:1.

In particular, the ratio of the linear thermal conductivity of the first and/or the second horizontal frame profile 420a, 420b to the thermal conductivity of the first and/or second insulating web 480a, 480b ranges between 50:1 to 800:1, preferred between 75:1 to 750:1.

The ceiling-side horizontal door leaf frame 410ab, 410bb, 410cb, 410db comprises means 434a, 434b for connecting the horizontal door frame to the roller carriage 500. The means are in particular configured as a shoulder 434a, 434b, at which an attachment element of the roller carriage 500 can reach under or engage.

The first horizontal frame profile 420a and preferably also the second horizontal frame profile 420b include a groove-shaped reception at least at one narrow side 423a, 423b.

The first horizontal frame profile 420a and the second horizontal frame profile 420b include respectively at least one, preferably at least two, in particular preferred at least three groove-shaped receptions 425a, 426a, 427a, 425b, 426b, 427b at least at one of the long sides 421a, 422a, 421b, 422b directed to the outside, wherein at least one groove-shaped reception 425a, 426a, 425b, 426b, preferably at least two groove-shaped reception 425a, 426a, 425b, 426b are configured for the non-positive and/or positive reception of insulating webs 480a, 480b.

The groove-shaped reception 425a, 426a, 425b, 426b are configured essentially geometrically identical.

Tow of the groove-shaped receptions 425a, 426a, 425b, 426b are respectively disposed at the distal end of the long side 421a, 422a, 421b, 422b oriented to the outside of the horizontal frame profile 420a, 420b.

One of the long sides 421a, 422a, 421b, 422b of the horizontal profile 420a, 420b comprises an extension 430 in true alignment with the long sides 421a, 422a, 421b, 422b, wherein at the distal end of the extension at least one groove-shaped reception 429 is configured in particular for the reception of a sealing profile.

Furthermore, it is preferred, if the wall thicknesses of the long sides 421a, 422a of the first horizontal frame profile 420a, of the second horizontal frame profile 420b as well as of the extension 430 are constant, wherein it is particularly preferred, if the ratio of wall thickness of the second horizontal frame profile 420b to the wall thickness of the extension 430 of the second horizontal frame profile 420b ranges between 0.9:1 to 1.1:1, preferred 0.95:1 to 1.05:1, particularly preferred amounts to approximately 1:1, and furthermore preferred the ratio of wall thickness of the first horizontal frame profile 420a to wall thickness of the second horizontal frame profile 420b ranges between 0.9:1 to 1.1:1, preferred 0.95:1 to 1.05:1, in particular preferred amounts to 1:1.

Furthermore, it is preferred, if the first horizontal frame profile 420a has a ratio of frame profile height (H_{VR1}) to frame profile width (B_{HR1}) of 1.1:1 to 5:1, preferred of 2:1 to 4.5:1, in particular preferred of 3:1 to 4:1, most particularly preferred approximately 3.67:1. Furthermore, it is also preferred, if the second horizontal frame profile 420b has a ratio of frame profile height (H_{VR2}) to frame profile width (B_{HR2}) of 1.1:1 to 5:1, preferred 2:1 to 4:1, in particular preferred of 2:1 to 3:1, and most particularly preferred of approximately 2.89:1.

According to another preferred embodiment of the disclosure, the ratio of frame profile height (H_{HR1}) to frame profile width (B_{HR1}) of the first horizontal frame profile 420a to the ratio of frame profile height (H_{HR2}) to frame profile width (B_{HR2}) of the second vertical frame profile 420b ranges between 1.1:1 to 2:1, preferred 1.1:1 to 1.5:1, in particular preferred amounts to approximately 1.27.

The ratio of the width (B_{HIS}) of the insulating webs 480a, 480b in a horizontal door leaf frame 410 to the width (B_{HR1}) of the first horizontal frame profile 420a ranges preferably between 1:1 to 3:1, preferred 1.5:1 to 2.5:1, in particular preferred 1.75:1 to 2.25:1.

Furthermore, the first horizontal frame profile 420a may have a first horizontal sight height (H_{HS1}) and the second horizontal frame profile 420b have a second horizontal sight height (H_{HS2}), wherein the ratio of the sight heights (H_{HS1}):(H_{HS2}) ranges between 1:1 to 1:2, preferred 1:1 to 1:1.5.

It is likewise preferred, if the ratio of horizontal sight height (B_{HS}) of a horizontal door leaf frame 410 to horizontal sight height (H_{HS2}) of the second horizontal frame profile 420b amounts to 1:1 to 1:3, preferred 1:1 to 1:2, in particular preferred 1:1.5 to 1:2.

As also revealed in FIG. 4, the first horizontal frame profile 420 and the second frame profile 420b, except for the extension 430 of the second frame profile 420b, are configured in cross-section essentially geometrically identical.

The groove-shaped receptions 427a, 427b are in particular intended as guide and anti-friction bearing of the guiding means 808, 809.

Furthermore, FIG. 4 in conjunction with FIG. 2 reveal that a horizontal frame profile 420 is able to accommodate at least one brush 490 for sealing the horizontal gap between the door leaf element 400 and the running rail 300 or the building floor 101, wherein means for the vertical adjustment of the brush in the frame profile are provided within the horizontal frame profile 420, wherein said means for the vertical adjustment of the brush 490 in the frame profile 420 comprise:
a brush profile 491, in which the brush 490 is accommodated, and
an essentially U-shaped reception 432 in the horizontal frame profile 420, in which the brush profile 491 is accommodated to be vertically adjustable and/or latchable.

In the area of the insulating web receptions 425, 426, 455, 456, the horizontal and/or vertical frame profiles 420, 440 have a surface roughness Ra of 0.05 to 1 μm, preferred approximately 0.5 μm, measured according to DIN EN ISO 4287, and an internal surface creasing essentially parallel to the longitudinal extension of the frame profiles 420, 440 of a door leaf element 400. Hereby, a gliding of the profiles with regard to the insulating web is simplified, in particular for compensating thermal tension and expansion of the profiles in the sliding wall system 100.

Preferably, the horizontal and/or vertical frame profiles 420, 440 respectively have a modulus of elasticity at 20° C. of 60 kN/mm² to 80 kN/mm², preferred approximately 70 kN/mm², according to EN ISO 6892-1:2009, a shear modulus at 20° C. of 10 to 40 kN/mm², preferred approximately 27 kN/mm², according to DIN 53445.

Preferably, the insulating webs 480a, 480b have a modulus of elasticity at 20° C. of 2 kN/mm² to 4 kN/mm², preferred approximately 3 kN/mm², according to ISO 527-1/-2, a shear modulus at 20° C. of 0.5 kN/mm² to 1 kN/mm², preferred approximately 0.8 kN/mm², according to DIN ISO 1827:2010-07. Furthermore, the surface roughness of the insulating webs 480a, 480b, in particular in the reception area to the frame profiles 420, 440 has a surface roughness Ra of 0.01 to 3 μm, preferred of 0.05 μm to 2 μm, according to DIN EN ISO 4287.

It is in particular preferred, if the surface pressure between the insulating webs 480a, 480b and the insulating receptions 425, 426, 455, 456 ranges between 120 to 200 N/mm². These values effects a sufficient good structural connection between the insulating webs 480a, 480b and still allows for gliding of the structural components with regard to each other for compensating thermally induced tension and material expansion.

FIG. 5 shows a cross-section through the drainage rail 600 of the sliding wall system 100. The drainage rail 600 may be provided as an optional feature to the sliding wall system 100. Basically, it is likewise possible to embody the sliding wall system 100 without a drainage rail 600.

Thus, preferably the horizontal sliding wall system 100 includes a drainage rail 600 recessed into the building floor 101 and disposed in true alignment below the travel path of a door leaf element 400. The drainage rail 600 comprises a first drainage profile 610 and at least one second drainage profile 620 as well as a first insulating web 480a and at least one second insulating web 480b, wherein the first drainage profile 610 and the second drainage profile 620 are fixed to be spaced apart by means of the first insulating web 480a and the second insulating web 480b.

Preferably, the drainage rail 600 is configured to be essentially flush with the building floor 101.

As can be well seen in FIG. 5, the first drainage profile 610 and the second drainage profile 620 are configured in cross-section to be essentially rectangularly.

The first drainage profile 610 or/and the second drainage profile 620 is/are in particular made from a material, which has a thermal conductivity of 75 to 235 W m⁻¹ K⁻¹ at 20° C., determined according to DIN EN ISO 10456 and a linear thermal expansion coefficient of 21 to 24*10⁻⁶ K⁻¹ at 20° C., determined according to DIN 51045. At least one, preferably each insulating web 480c1, 480c2 is made from a material, which has a thermal conductivity of 0.02 to 0.1 W m⁻¹ K⁻¹ at 20° C., determined according to DIN EN ISO 22007 and a linear thermal expansion coefficient of 40 to 300*10⁻⁶ K⁻¹ at 20° C., determined according to DIN 51045.

It is preferred, if the first drainage profile 610 and the second drainage profile 620 are configured to be geometrically identical. Furthermore, in this context, it may be advantageous, if the ratio of thermal conductivity of the first drainage profile 610 to the thermal conductivity of the second drainage profile 620 ranges between 0.9:1 to 1.1:1, preferred 0.95:1 to 1.05:1, in particular preferred amounts to approximately 1:1.

As can be seen in a combined view of FIG. 1 and FIG. 5, a door leaf element 400 comprises at least two vertical door frames 440a, 440b, and at least two horizontal door frames 410a, 410b, wherein both vertical frame profiles 450a, 450b of a vertical door frame 440a, 440b are connected to each other spaced apart by means of at least two insulating webs 480a, 480b by an essentially identical width B_{VIS} (compare FIG. 3) and the two horizontal frame profiles 420a, 420b of a horizontal door frame 410a, 410b are connected each other to be spaced apart by means of at least two insulating webs 480a, 480b by an essentially identical width B_{HIS} (compare FIG. 4), and the drainage profiles 610, 620 of the drainage rail 600 are connected each other by means of at least two insulating webs 480c1, 480c2 to be spaced apart by an essentially identical width B_{DIS}, wherein furthermore B_{VIS}=B_{HIS}=B_{DIS}.

Furthermore, it can be seen that a door leaf element 400 comprises at least two vertical door frames 440a, 440b and at least two horizontal door frames 410a, 410b, wherein the two vertical frame profiles 450a, 450b of a vertical door frame 440a, 440b are connected to each other spaced apart by means of at least two insulating webs 480a, 480b (compare FIG. 3), and the two horizontal frame profiles 420a, 420b of a horizontal door frame 410a, 410b are connected to each other spaced apart by means of at least two insulating webs 480a, 480b (compare FIG. 4), wherein at least one of the insulating webs 480a, 480b, 480c1, 480c2 is configured in a vertical door frame 440a, 440b, a horizontal door frame 410a, 410b and in the drainage rail 600 to be geometrically essentially identical.

It is also preferred, if the door leaf element 400 comprises at least two vertical door frames 440a, 440b and at least two horizontal door frames 410a, 410b, wherein the two vertical frame profiles 450a, 450b of a vertical door frame 440a, 440b are connected to each other spaced apart by means of at least two insulating webs 480a, 480b (compare FIG. 3), and the two horizontal frame profiles 420a, 420b of a horizontal door frame 410a, 410b are connected to each other spaced apart by means of at least two insulating webs 480a, 480b (compare FIG. 4), wherein at least one, preferably all of the insulating webs 480a, 480b, 480c1, 480c2 is/are configured in a vertical door frame 440a, 440b, a horizontal door frame 410a, 410b and in the drainage rail 600 to be essentially of identical material.

In another preferred embodiment of the disclosure, the door leaf element 400 comprises at least two vertical door frames 440a, 440b and at least two horizontal door frames 410a, 410b, wherein the two vertical frame profiles 450a, 450b of a vertical door frame 440a, 440b have an essentially identical width B_{VR1} (compare FIG. 3), and the two horizontal frame profiles 420a, 420b of a horizontal door frame 410a, 410b have an essentially identical width B_{HR1} (compare FIG. 4), and the drainage profiles 610, 620 of the drainage rail 600 have an essentially identical width B_{DP1}, wherein furthermore B_{VR1}=B_{HR1}=B_{DP1}.

Finally, with the intention to further improve the thermal separation in the floor area, it is likewise preferred, if the door leaf element 400 comprises a horizontal frame profile 420, in which at least one brush 490 for sealing the horizontal gap between the door leaf element 400 and the building floor 101 is accommodated, wherein means for vertical adjustment of the brush in the frame profile are provided within the horizontal frame profile 420.

As can be furthermore seen in FIG. 5, the essentially rectangular profile, on the inside, may include connecting webs between the long sides, which webs are configured preferably in one piece, in particular monolithically with the profile. On the one hand, this configuration allows for increasing the structural stability of a drainage profile 610, 620, and on the other hand, the channels formed within the drainage profile 610, 620 allow for a defined draining of drainage water.

For draining the drainage water, the upper insulating web 480c1 includes at least one opening 481, through which drainage water can flow into the drainage rail 600. For controlled draining of the drainage water, at least one opening 612 is provided in at least one drainage profile 610, 620, which opening connects the inside of the drainage rail to the inside of a drainage profile 610, 620. Furthermore, at least one further opening 611 may be disposed at the side of the drainage profile 610, 620 facing to the outside, if draining of the drainage water is intended to happen outside the drainage profile 610, 620.

At their facing sides, the drainage profiles 610, 620 include respectively one shoulder 614, 624. Said shoulders 614, 624 serve for attaching, in particular for a stationary pivot bearing for a swing sliding leaf 400b. For this purpose, in particular an attachment element may be pushed into the drainage rail 600 and rests on the shoulders 614, 624 or encloses them at least partially. The stationary pivot bearing is then configured in said reception, for example by means of a bushing, in which the bolt 804 of the swing sliding leaf door 400b is supported to be rotatably guided.

On the side facing the building ceiling 201, the upper insulating web 480c1 includes a channel-like, essentially U-shaped configured surface structure, whereby the drainage water is collected and conducted in a controlled manner into the openings 481 for a controlled draining.

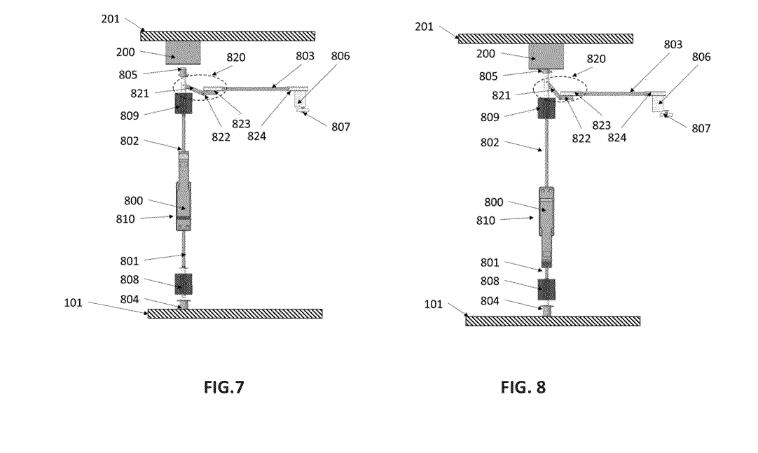

Groove-shaped receptions 615, 625 for accommodating at least one insulating web are provided at or in a lateral wall of the drainage profile 610, 620. The groove-shaped receptions are configured as shown in FIG. 7, such that it is referred to the corresponding description.

Furthermore, at the ceiling-side the drainage profiles 610, 620 have receptions 613, 623, into which a cover profile 627 can be affixed in a positive and/or non-positive manner. The cover profile 627 may be configured in particular in an L-shape, wherein preferably for covering respectively one cover profile 627 is positioned in the reception 613 and 623. In FIG. 5, this is indicated for the right drainage profile 610. The cover profile 627 allows in particular for a aesthetically pleasing floor termination to the drainage rail 600.

In particular in the area of the insulating web receptions 625, 626, 615, 616, the drainage profiles 610, 620 have a surface roughness Ra of 0.05 to 1 μm, preferred approximately 0.5 μm, measured according to DIN EN ISO 4287, and an internal surface creasing essentially parallel to the longitudinal extension of the frame profiles 610, 620. Hereby, a gliding of the profiles with regard to the insulating web is simplified, in particular for compensating thermal tension and expansion of the profiles in the sliding wall system 100.

Preferably, the drainage profiles 610, 620 have a modulus of elasticity at 20° C. of 60 kN/mm² to 80 kN/mm², preferred approximately 70 kN/mm², according to EN ISO 6892-1:2009, a shear modulus at 20° C. of 10 to 40 kN/mm², preferred approximately 27 kN/mm², according to DIN 53445.

Preferably, the insulating webs 480c1, 480c2 have respectively a modulus of elasticity at 20° C. of 2 kN/mm² to 4 kN/mm², preferred approximately 3 kN/mm², according to ISO 527-1/-2, a shear modulus at 20° C. of 0.5 kN/mm² to 1 kN/mm², preferred approximately 0.8 kN/mm², according to DIN ISO 1827:2010-07. Furthermore, the surface roughness of the insulating webs 480c1, 480c2, in particular in the reception area to the drainage profiles 610, 620 has a surface roughness Ra of 0.01 to 3 μm, preferred of 0.05 μm to 2 μm, according to DIN EN ISO 4287.

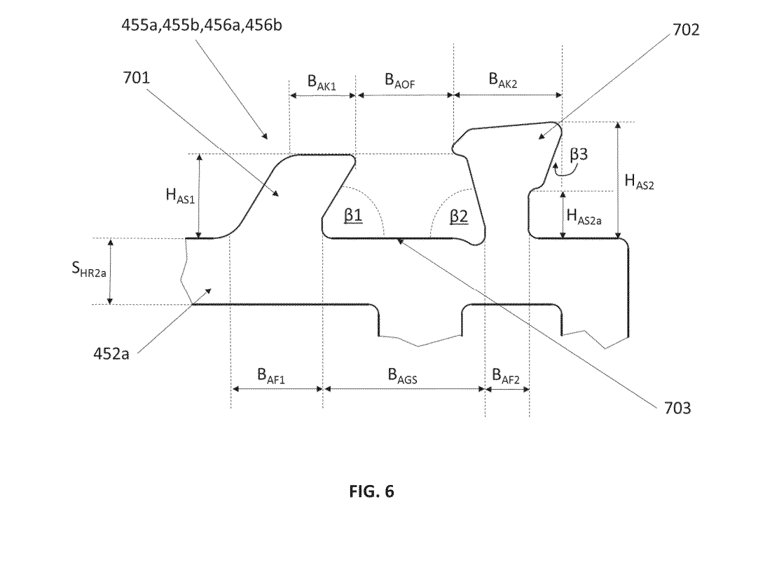

FIG. 6 shows a detailed view of a groove-shaped reception 455a, 455b, 456a, 456b for an insulating web 480a, 480b configured in a door leaf element 400.

The groove-shaped receptions 455a, 455b, 456a, 456b are essentially configured U-shaped with a first free branch 701, a second free branch 702, and a base side 703, from which the free branches 701, 702 extend. The opposite surfaces of the free branches 701, 702 of the U-shaped groove-like receptions 455a, 455b, 456a, 456b are placed at an angle β1 and β2 between 25° and 85°, preferred 45° to 75°, most particularly preferred 50° to 75° with regard to the basic side 703 of the groove-shaped receptions 455a, 455b, 456a, 456b one on top of the other and facing each other. It is most particularly preferred, if the angle β1 ranges between 50° and 60° and the angle β2 between 60° and 80°.

Furthermore, it is preferred as can be seen in FIG. 6 as well, if the free branches 701, 702 of the U-shaped groove-shaped receptions 455a, 455b, 456a, 456b protrude from the long sides 452a, and the basic side 703 of the groove-shaped receptions 455a, 455b, 456a, 456b is configured to be aligned with the long sides 452a.

The basic side of the groove-shaped reception 455a, 455b, 456a, 456b has a width B_{AGS} and an opening portion with a width B_{AOF}, wherein the ratio of B_{AGS} to B_{AOF} ranges between 2.5:1 to 1.5:1, preferred 2:1 to 1.5:1.

The first free branch 701 has a height H_{AS1} and the second free branch has a height H_{AS2}, wherein the ratio of H_{AS1} to H_{AS2} ranges between 1.1:1 to 2:1, preferred 1.25:1 to 1.75:1.

At its foot, the first free branch 701 has a width B_{AF1} and at its head a width B_{AK1}, wherein the ratio of B_{AF1} to B_{AK1} ranges between 0.8:1 to 1.2:1.

At its foot, the second free branch 702 has a width B_{AF2} and at its head a width B_{AK2}, wherein the ratio of B_{AF2} to B_{AK2} ranges between 2:1 to 1.4:1, preferred 2.25:1 to 3:1.

The long side 452a of the profile 450 has a thickness of S_{HR2a}, wherein the ratio of thickness S_{HR2a} to width B_{AF2} of the second free branch 702 ranges between 1.25:1 to 2:1, preferred 1.25:1 to 1.75:1.

Preferably, the groove-shaped reception 455a, 455b, 456a, 456b extends over the entire length of a profile.

It is particularly preferred, if all groove-shaped receptions 455a, 455b, 456a, 456b, 425a, 425b, 426a, 426b for the reception of insulating webs 480a, 480b in vertical and horizontal door leaf frames 410, 440 within the sliding wall system 100 are configured to be essentially identical.

Furthermore, it is preferred, if all groove-shaped receptions 455a, 455b, 456a, 456b, 425a, 425b, 426a, 426b for the reception of insulating webs 480a, 480b in vertical and horizontal door leaf frames 410, 440, as well as all groove-shaped receptions 615a, 615b, 616a, 616b for the reception of insulating webs 480a, 480b in a drainage rail 600 within the sliding wall system 100 are configured to be essentially identical.

FIG. 7 shows a functional outline of an interlocking for a sliding pivoting door 400b known from FIG. 1 in the sliding condition. The ceiling guide 200 is affixed to a building ceiling 201. The door leaf element 400b, in which the interlocking to be explained in detail in the following is accommodated, is disposed in the ceiling guide 200 to be displaceable and pivotable and is configured as a swing sliding leaf 400b The swing sliding leaf 400b comprises a swing leaf door 401 (also compare FIG. 1), which is disposed at the horizontal frame profile 410bb and/or the vertical frame profile 440ba of the swing sliding leaf 400b to be pivotable.

Furthermore, the swing sliding leaf 400b comprises an interlocking handle 800, which is configured between a first interlocking position and a second interlocking position. In the illustrated exemplary embodiment, the interlocking handle 800 is configured as a knob rotatable by 180°, which is pivotable between a position pointing to the building floor 101 and a position pointing to the building ceiling 201. The two interlocking conditions are shown in FIG. 7 and FIG. 8, wherein FIG. 7 shows the displacement condition and FIG. 8 shows the pivoting condition of the swing sliding leaf 400b.

A first gear arrangement 810 (not visible) is coupled to the interlocking handle 800, wherein the first gear arrangement 810 transforms the rotary motion of the interlocking handle 800 into a vertical translatory motion of a first interlocking rod 801 and of a second interlocking rod 802.

The second gear arrangement 820 is coupled to at least one of the interlocking rods 801, 802, such that the vertical translatory motion of one of the interlocking rods 801, 802 is transformed into a horizontal movement of a third interlocking rod 803. In the illustrated exemplary embodiment, the second interlocking rod 802 is coupled to the second gear arrangement 820.

At its ceiling-side distal end, the second interlocking rod 802 includes an interlocking bolt 805, which, in the first interlocking position of the interlocking handle 800, engages in a stationary pivot bearing. This condition is shown in FIG. 8. The stationary pivot bearing may be configured in the ceiling guide 200 and/or the building ceiling.

Likewise at its floor-side end, the first interlocking rod 801 includes an interlocking bolt 805, which, in the first interlocking position of the interlocking handle 800, engages in a floor-side stationary pivot bearing, such that a rotary motion of the swing sliding leaf 400b can be caused about the interlocking rods 801, 802, and displacing the door leaf element 400b is prevented (compare FIG. 8). In the second interlocking position of the interlocking handle 800, a rotary motion of the swing sliding leaf 400b about the interlocking rods 801, 802 is prevented and displacing the door leaf element 400b is enabled, which is shown in FIG. 7.

The floor-side stationary pivot bearing may be disposed in particular likewise in a drainage rail 600. For this purpose, it may be intended to dispose a bearing bushing, in which the interlocking bolt 805 engages, at and/or in the drainage rail 600. A corresponding opening may be provided for this purpose in an insulating web 480c, into which the bearing bushing is inserted and stationarily fixed. With said thermal separation, which here also continues in the floor-side pivot bearing, the insulating effect of the sliding wall system can be further improved.

As can be clearly seen in FIG. 7 and FIG. 8, the first interlocking rod 801 and the second interlocking rod 802 are disposed to be in true alignment on a common vertical axis.

The third interlocking rod 803 has coupling means 806, which, in the second interlocking position of the interlocking handle 800, are in engagement with a corresponding coupling means 807 of the swing leaf door 401, such that a rotary motion of the swing sliding leaf 400b about the interlocking rods 801, 802 is prevented, however, displacing the door leaf element 400b is enabled (compare FIG. 7).

The second gear arrangement 820 comprises at least one first lever 821 and a second lever 822, wherein the first lever 821 is articulately supported at the second interlocking rod 802 and articulately supported at the second lever 822, wherein the second lever 822 is supported to be displaceable in the horizontal door leaf frame 410bb of the door leaf 400b. The second lever 822 is coupled to the interlocking rod 803, for example by means of a screw connection and/or a latching connection.

The third interlocking rod 803 is guided to be displaceable in the horizontal door leaf frame 410bb. The interlocking rod 803 is coupled to two sliding elements 823, 824 for this purpose, which are accommodated to be displaceable in the horizontal door leaf frame 410bb of the door leaf 400b. In other words, the interlocking rod 803 contacts the profiles of the horizontal door frame exclusively via the sliding elements 823, 824, in order to guarantee thereby in particular a good thermal separation between the inside and the outside of the horizontal frame profile. For this purpose, a sliding element 823, 824 has a thermal conductivity of 0.1 to 2 W m⁻¹ K⁻¹, preferred of 0.1 to 1.5 W m⁻¹ K⁻¹, in particular preferred of 0.1 to 1 W m⁻¹ K⁻¹ at 20° C., determined according to DIN 52612, and has a thermal linear expansion coefficient of 0.1 to 2, preferred of 0.5 to 1.5, in particular preferred of 0.5 to 1.0*10⁻⁶ K⁻¹ at 20° C., measured according to DIN 11359.

The sliding elements 823, 824 are in particular guided in the groove-shaped receptions 427a, 427b of the horizontal door leaf profile 410bb.

Furthermore, the third interlocking rod 803 includes coupling means 806, which comprise a groove-shaped reception, in which a corresponding coupling means of the swing leaf door 401 can be brought into positive engagement.

The interlocking handle 800 shown in FIG. 7 and FIG. 8 is disposed on a vertical frame on the pull-side.

The first interlocking rod 801 and the second interlocking rod 802 are vertically guided in at least one guide 808, 809. The guide 808, 809 is disposed within a vertical frame 440bb of the door leaf element 400 to be detachable and displaceable. The guide 808, 809 may be non-positively and/or positively fixable within the vertical frame 440bb.

With the intention of guarantee sufficiently good thermal separation at the vertical frame 440bb, a guide 808, 809 presents a thermal conductivity of 0.1 to 2 W m⁻¹ K⁻¹, preferred of 0.1 to 1.5 W m⁻¹ K⁻¹, in particular preferred of 0.1 to 1 W m⁻¹ K⁻¹ at 20° C., determined according to DIN 52612, and has a thermal linear expansion coefficient of 0.1 to 2, preferred of 0.5 to 1.5, in particular preferred of 0.5 to 1.0*10⁻⁶ K⁻¹ at 20° C., measured according to DIN 11359.

1. A horizontal sliding wall system, comprising a ceiling guide with at least one running rail, as well as at least one door leaf element, which is connected to a roller carriage, which is disposed in the ceiling guide to be displaceable, wherein
at least one door leaf element is configured as a swing sliding leaf to be pivotable and displaceable in the ceiling guide,
wherein the swing sliding leaf comprises a swing leaf door, as well as
an interlocking handle, which is configured to be rotatable between a first interlocking position and a second interlocking position, and
a first gear arrangement, and
a second gear arrangement,
wherein the first gear arrangement transforms the rotary motion of the interlocking handle into a vertical translatory motion of a first interlocking rod and of a second interlocking rod, wherein the second gear arrangement is coupled to at least one of the interlocking rods, such that the vertical translatory motion of one of the interlocking rods is transformed into a horizontal movement of a third interlocking,
the second interlocking rod, at its ceiling-side distal end, includes an interlocking rod, which, in the first interlocking position of the interlocking handle, engages in a stationary pivot bearing, and the first interlocking rod, at its floor-side end, includes an interlocking bolt, which, in the first interlocking position of the interlocking handle, engages in a floor-side stationary pivot bearing, such that a rotary motion of the swing sliding leaf about the interlocking rods can be caused, and a displacement of the door leaf element is prevented, wherein, in the second interlocking position of the interlocking handle, a rotary motion of the swing sliding leaf about the interlocking rods is prevented, and a displacement of the door leaf element is enabled, wherein
the third interlocking rod includes a coupling means, which, in the second interlocking position of the interlocking handle, is in engagement with a corresponding coupling means of the swing leaf door, such that a rotary motion of the swing sliding leaf about the interlocking rods is prevented and displacing the door leaf element is enabled.

2. The horizontal sliding wall system according to claim 1, wherein the second gear arrangement comprises at least one first lever and a second lever, wherein the first lever is articulately supported at the second interlocking rod and articulately supported at the second lever, wherein the second lever is accommodated to be displaceable in the horizontal door leaf frame of the door leaf.

3. The horizontal sliding wall system according to claim 1, wherein the second lever is coupled to the interlocking rod.

4. The horizontal sliding wall system according to claim 1, wherein the third interlocking rod is guided to be displaceable in the horizontal door leaf frame.

5. The horizontal sliding wall system according to claim 1, wherein the interlocking rod coupled to at least one, preferred two sliding elements, which are accommodated to be displaceable in the horizontal door leaf frame of the door leaf.

6. The horizontal sliding wall system according to claim 1, wherein the a sliding element has a thermal conductivity of 0.1 to 2 W m⁻¹ K⁻¹, and a linear thermal expansion coefficient of 0.1 to 2.

7. The horizontal sliding wall system according to claim 1, wherein the third interlocking rod includes coupling means, which comprises a groove-shaped reception, in which a corresponding coupling means of the swing leaf door can be brought into positive engagement.

8. The horizontal sliding wall system according to claim 1, wherein the first interlocking rod and the second interlocking rod are disposed in true alignment on a common vertical axis.

9. The horizontal sliding wall system according to claim 1, wherein the interlocking handle is disposed on a vertical frame on the pull-side.

10. The horizontal sliding wall system according to claim 1, wherein the first interlocking rod is vertically guided in at least one guide and/or the second interlocking rod is vertically guided in at least one guide.

11. The horizontal sliding wall system according to claim 1, wherein the guide is disposed within a vertical frame to be detachable.

12. The horizontal sliding wall system according to claim 1, wherein the guide is disposed within the vertical frame to be displaceable.

13. The horizontal sliding wall system according to claim 1, wherein the guide is disposed within the vertical frame to be non-positively and/or positively fixable.

14. The horizontal sliding wall system according to claim 1, wherein the guide has a thermal conductivity of 0.1 to 2 W m⁻¹ K⁻¹, and has a linear thermal expansion coefficient of 0.1 to 2.

15. The horizontal sliding wall system according to claim 1, wherein a stationary pivot bearing is configured in the ceiling guide and/or the building ceiling.
